(19) United States
(12) Patent Application Publication
(10) Pub. No.: US 2005/0117800 A1
(43) Pub. Date: Jun. 2, 2005

(54) Video processing

(76) Inventor: Jonathan Diggins, Eastleigh Hampshire (GB)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/504,507

(22) PCT Filed: Feb. 13, 2003
(86) PCT No.: PCT/GB03/00636

(30) Foreign Application Priority Data
Feb. 13, 2002 (GB) 0203409.8

(51) Int. Cl. G06K 9/00; G06K 9/46

(52) U.S. Cl. 382/170; 382/190

(57) ABSTRACT

In analyzing a picture sequence, a distribution of values of at least one variable of an input picture signal is generated. A measure of the spread of the distribution is then derived, at a particular resolution. Further such measures of the spread of the distribution are then derived, at a plurality of different resolutions. These measures are then compared in order to determine a characteristic of the picture sequence, such as fractal dimension.

This invention is directed to the analysis of image material, and in particular aspects to the determination of certain characteristics of image sequences.

The analysis of picture sequences, such as video, is instrumental in various broadcasting, standards conversion, production, editing and other image manipulation processes. There are a number of techniques known to the art in this field. However, there are various problems associated with such techniques. In a particular example, current techniques for distinguishing between film and video material sources are unreliable.

It is therefore an object of the invention to provide an improved system for the analysis of picture material.

Accordingly, the present invention consists in one aspect in a method of analyzing a picture sequence, comprising the steps of receiving an input picture signal, generating a distribution of values of at least one variable of the picture signal, deriving, at a resolution N, a measure of the spread of the distribution, deriving further measures of the spread of the distribution for a plurality of values of N, and comparing the measures derived to determine a characteristic of the picture sequence.

This technique permits the measurement of subtle characteristics of picture material and picture sequences which are commonly overlooked by existing analysis techniques.

In embodiments, the step of deriving a measure of the spread of the distribution comprises calculating the probability that a given region of the distribution space is occupied by a value of the distribution, or determining whether a given region of the distribution space is occupied by a value of the distribution.

Advantageously, the step of comparing the measures comprises determining from the measure the fractal dimension of the distribution, and using the fractal dimension to determine the characteristic of the picture sequence.

In one embodiment, the step of generating the distribution comprises measuring differences between two or more pictures of the sequence, and assigning the two or more difference signals as orthogonal variables in the distribution space. Suitably, the characteristic determined is the type of picture sequence input, or the type of frame of the current picture.

In another embodiment, the step of generating a distribution comprises isolating a picture of the sequence for analysis. Suitably, the characteristic determined is the segmentation into objects of the pictures in the sequence, or an estimate of the noise in the picture sequence.

In another aspect, the invention provides apparatus for analyzing a picture sequence, comprising: a picture signal input; a processor for generating a distribution of values of at least one variable of the picture signal; a calculator for deriving, at a resolution N, a measure of the spread of the distribution, and for deriving further measures of the spread of the distribution for a plurality of values of N; and a comparator for comparing the measures derived to determine a characteristic of the picture sequence.

The invention will now be described by way of example, with reference to the accompanying drawings, in which:

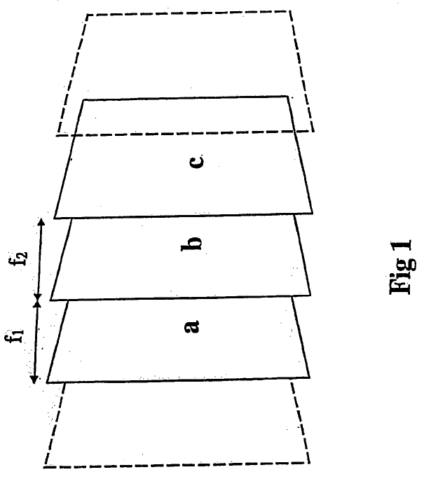

FIG. 1 is a diagram illustrating a sequence of pictures;

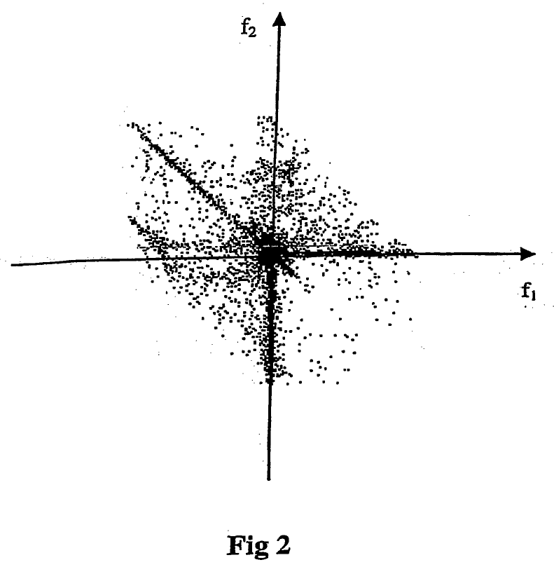

FIG. 2 is a diagram illustrating a distribution derived from the sequence illustrated in FIG. 1, according to an embodiment of the invention;

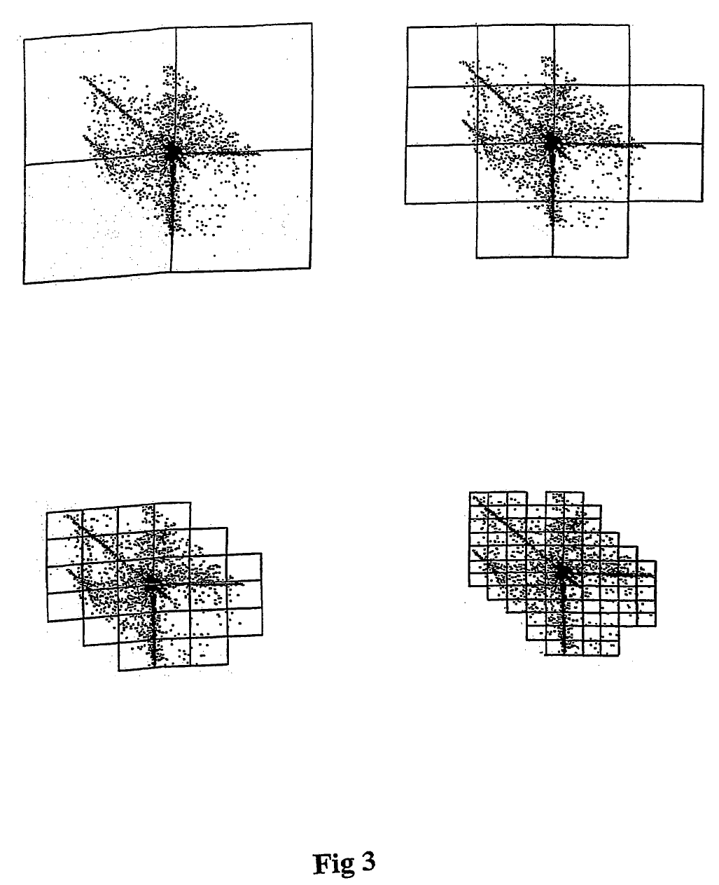

FIGS. 3a to 3d are diagrams illustrating the measurement of the fractal dimension of the distribution of FIG. 2, according to an embodiment of the invention;

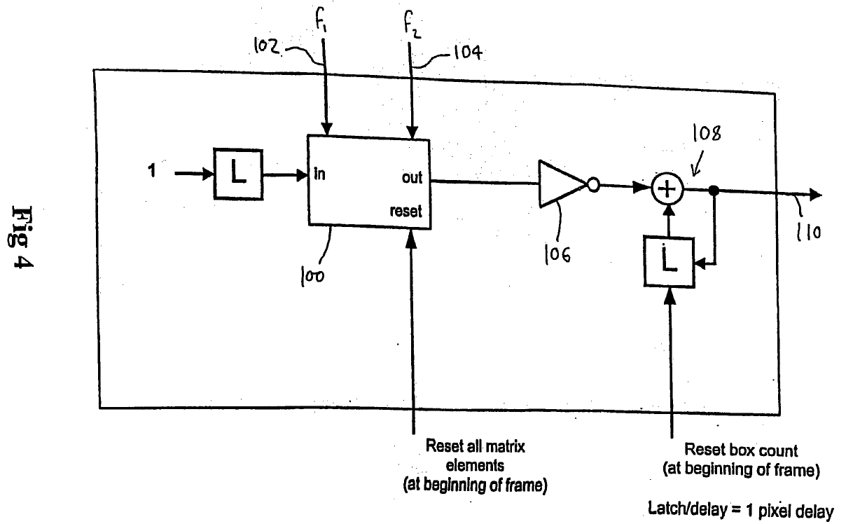

FIG. 4 is a diagram illustrating a counting system according to an embodiment of the invention; and

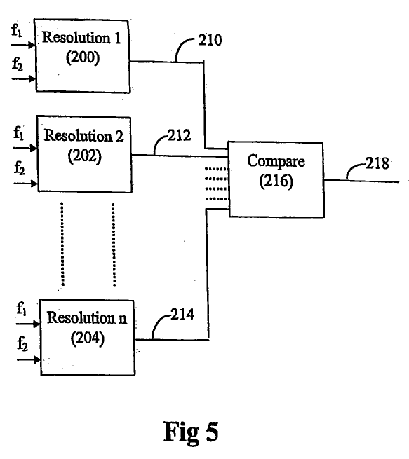

FIG. 5 is a diagram illustrating apparatus comparing the results of systems such as that illustrated in FIG. 4.

The invention is applicable to various methods of analysis of picture sequences. An instructive example is the common need to identify whether a given sequence originated from a film or a video source. Applications such as compression, standards conversion, and adaptive image filtering make use of source content information in order to optimize their performance.

Given a picture sequence, such as a video sequence comprising a number of fields, it is possible to measure the differences between fields. FIG. 1 shows a sequence of fields, with a set of chosen fields a, b and c. The differences f₁ and f₂ are those between the first and second, and the second and third fields, respectively. In this example, the difference taken is the luma difference between corresponding pixels in the two fields. It should be noted that a variety of techniques may be used to find field differences.

Taking the three sequential frames a, b and c, the differences at one pixel location, P, can be defined as f₁=P_{b}−Pₐ and f₂=P_{c}−P_{b}. FIG. 2 is a plot of the field differences for a particular sequence of video. In this case, the distribution is spread in various directions across the field difference space. The field difference space distributions from film sources and video sources tend to have some immediately apparent distinguishing characteristics, though these alone are not sufficient to provide a reliable differentiation.

The inventors have determined, however, that film material and video material have different fractal dimensions. Fractal dimension is in this context effectively a measure of the structure within a distribution of points in field difference space, as outlined below. Video motion tends to have an underlying structure or ‘lumpiness’ that is different from film noise.

Principally, this is because in video, each field originates from a different point in time. With film that has been tele-cined, pairs of fields can originate from the same point in time (i.e. a particular film frame), or—as with 3:2 pulldown—from two different points in time (different film frames). Film tends to have motion between only two of the three fields under consideration. Video has motion between each pair of the three and therefore extends into two directions in the field difference space. Film typically yields a fractal dimension of around 1.0 and video, a fractal dimension nearer to two.

Fractional dimension in general is observed in curves or distributions which do not obey classical “rules”. For well behaved curves, one would expect that the number of rulers required N_{Δ} to measure a length L(Δ) would scale inversely proportional to ruler size Δ; for example, halving the ruler size should double the number of lengths required. Fractal curves (such as coastlines) do not obey this apparently common-sense principle. Instead, their measured length depends on the size of the “ruler” used. What is found is that the number of ruler lengths is proportional to some (negative) power of the ruler size:

$${N}_{Δ} = \frac{L ( Δ )}{Δ} = \frac{{L}_{0}}{{Δ}^{d}}$$

The deviation from correct inverse proportionality scaling is characterised by the fractal dimension, d, in the factor 1/Δ^{d}.

With a result having two components, such as f₁ and f₂, an approach is to cover the object with areas or boxes, and count the number of boxes that are required to cover the object as a function of the box size. An example of this, applied to the distribution of FIG. 2, is shown in FIG. 3. The number of boxes required to cover the distribution at a particular resolution Δ (or “box size”) is counted. The numbers of boxes required for the different resolutions are then compared, using the above equation, to yield the fractal dimension of the distribution.

It will be clear to the skilled reader that a variety of similar means could be employed in order to implement the invention. For example, a three-dimensional plot may be analysed by means of a series of cubes. The measuring unit need not be square (or cubic), though such a property simplifies the calculations involved.

FIG. 4 shows a box counting circuit used in the above embodiment. A counter similar to this is employed at each box size or resolution. The boxes used to cover the plot define a matrix stored at box 100. The f₁ (102) and f₂ (104) values are input to the matrix, and the output is passed through the inverter (106) in order to avoid double (or further) counting of boxes. The number of boxes occupied is then counted at the adder and loop (108), to provide a box count output (110). The matrix and box count are reset at the beginning of each frame.

The subsequent calculation of the fractal dimension is schematically illustrated in FIG. 5. Counters 200, 202 and 204, similar those shown in FIG. 4 are employed, at resolutions “1”, ‘2’, and so forth, up to resolution “n”. The counts 210, 212 and 214 from these are then compared (216), and the fractal dimension d is calculated and output at 218.

In an alternative embodiment, the box 100 of FIG. 4 generates matrices at different resolutions, and a count 110 is produced for each resolution. The counts are then compared, as in box 216 of FIG. 5, for calculation of the fractal dimension.

It will be obvious to the skilled reader that any different number of resolutions of boxes may be used, provided enough are used to permit a measure of the change of size of the distribution (as a function of Δ) with the size (Δ) of box used, i.e. the fractal dimension.

In order to display and analyse the results of the methods described herein, it is typically instructive to plot the fractal dimension for a given sequence against another measure of the sequence, such as the difference of the field difference signals, f₁−f₂, or their logs (log f₁−log f₂). Clustering of points in a particular quadrant of such a plot gives an immediate indication as to whether the sequence is, for example, video or film.

In other embodiments, the described technique is modified to improve the accuracy of the results. For instance, in an embodiment, a coring function is applied to the values of f₁ and f₂, in order to better distinguish between the types of source material present. In other embodiments, where the material to be analysed is interlaced, a variety of de-interlacing techniques are used, those best suited to certain types and qualities of image input yielding better differentiation between video and film. In one embodiment, the absolute field difference values are used, rather than the differences for individual pixels.

The invention may also be employed for a variety of other methods of analysis of picture material. In an embodiment, the method described above for distinguishing between film and video sources is used for determining whether a particular field is a repeat field, or a first field of a film pair, for example. Such a technique (in conjunction with, or as an alternative to the previously described techniques) may be used to distinguish the specific type of video or film source, such as 3:2 film, rather than 2:2 film.

In a further embodiment, the method is employed in detecting a shot change in the sequence. In a still further embodiment, decompressed video material is analysed in order to determine whether in its previously MPEG encoded state a particular frame was an I, P or B frame. In such embodiments, a plot of the differences between fields or frames, f₁ and f₂, will have a different “texture” or fractal dimension depending on the characteristics of the frames analysed. For example, referring to FIGS. 1 and 2, in a video sequence in which frame c represented a shot change, a clustering of points may occur around the f₂ axis, due to higher differences between corresponding pixels of frames b and c.

In these examples, the difference in fractal dimension between successive frames is also employed to advantageous effect. For instance, the fractal dimension of a frame of video, rather than the f₁ vs. f₂ plot, may be taken, and compared with the previous frame(s).

Indeed, the fractal dimension or texture of many other types of distribution may also be measured for picture material analysis. For example, the distribution of noise in a particular picture may be measured, or compared with surrounding frames, in order to give an estimate of signal to noise ratios. In another embodiment, the fractal dimensions of certain areas of a particular picture, or of a sequence of pictures are used in a segmentation operation, to determine the boundaries of objects making up the picture(s).

It should also be noted that the invention is not limited to the measurement of fractal dimension of a given distribution. Other “dimensions” may also be measured, giving further information about the distribution, and hence further means for analysis of the picture material giving rise to the distribution. Rather than simply counting a box if it is occupied by a point, and thus giving a different count at different resolutions, higher order dimensions (such as “information dimension” and “correlation dimension”) measure factors such as how the count changes with increasing resolutions, and those characteristics which might be indicated by boxes being occupied by more than one point.

It will be appreciated by those skilled in the art that the invention has been described by way of example only, and a wide variety of alternative approaches may be adopted. In particular, the various techniques described may be employed with various types of picture sequence input, either uncompressed (or decompressed) material, such as video, or compressed material, such as MPEG.

1. A method of analyzing a picture sequence, comprising receiving an input picture signal, generating a distribution of values of at least one variable of the picture signal, deriving, at a resolution N, a measure of the spread of the distribution, deriving further measures of the spread of the distribution for a plurality of values of N, and comparing the measures derived to determine a characteristic of the picture sequence.

2. A method according to claim 1, wherein the step of deriving a measure of the spread of the distribution comprises calculating the probability that a given region of the distribution space of the distribution is occupied by a value of the distribution.

3. A method according to claim 1, wherein the step of deriving a measure of the spread of the distribution comprises determining whether a given region of the distribution space of the distribution is occupied by a value of the distribution.

4. A method according to claim 1, wherein the step of comparing the measures comprises determining from the measure the fractal dimension of the distribution, and using the fractal dimension to determine the characteristic of the picture sequence.

5. A method according to claim 1, wherein the step of generating the distribution comprises measuring differences between two or more pictures of the sequence, and assigning the two or more difference signals as orthogonal variables in the distribution space of the distribution.

6. A method according to claim 5, wherein the characteristic determined is the type of picture sequence input.

7. A method according to claim 5, wherein the characteristic determined is the type of frame of the current picture being analyzed.

8. A method according to claim 1, wherein the step of generating a distribution comprises isolating a picture of the sequence for analysis.

9. A method according to claim 8, wherein the characteristic determined is the segmentation into objects of the pictures in the sequence.

10. A method according to claim 8, wherein the characteristic determined is an estimate of the noise in the picture sequence.

11. Apparatus for analyzing a picture sequence, comprising: a picture signal input, a processor for generating a distribution of values of at least one variable of the picture signal, a calculator for deriving, at a resolution N, a measure of the spread of the distribution, and for deriving further measures of the spread of the distribution for a plurality of values of N; and a comparator for comparing the measures derived to determine a characteristic of the picture sequence.

12. The apparatus of claim 11, wherein deriving a measure of the spread of the distribution includes at least calculating the probability that a given region of the distribution space of the distribution is occupied by a value of the distribution.

13. The apparatus of claim 11, wherein deriving a measure of the spread of the distribution includes at least determining whether a given region of the distribution space of the distribution is occupied by a value of the distribution.

14. The apparatus of claim 11, wherein comparing the measures includes at least determining from the measure a fractal dimension of the distribution, and using the fractal dimension to determine the characteristic of the picture sequence.

15. The apparatus of claim 11, wherein the step of generating the distribution includes at least measuring differences between two or more pictures of the sequence, and assigning the two or more difference signals as orthogonal variables in a distribution space of the distribution.

16. The apparatus of claim 11, wherein the characteristic determined is the type of picture sequence input.

17. The apparatus of claim 11, wherein the characteristic determined is the type of frame of the current picture being analyzed.

18. The apparatus of claim 11, wherein the step of generating a distribution includes at least isolating a picture of the sequence for analysis.

19. The apparatus of claim 18, wherein the characteristic determined is the segmentation into objects of the pictures in the sequence.

20. The apparatus of claim 18, wherein the characteristic determined is an estimate of the noise in the picture sequence.
